(19) United States
(12) Patent Application Publication
(10) Pub. No.: US 2014/0197144 A1
(43) Pub. Date: Jul. 17, 2014

(54) Method and device for slitting thin strip magnetic steel

(71) Applicants: Keith D. Earhart, Waxhaw, NC (US); John S. Hurst, Indian Trail, NC (US)

(72) Inventors: Keith D. Earhart, Waxhaw, NC (US); John S. Hurst, Indian Trail, NC (US)

(73) Assignee: Keith D. Earhart

(21) Appl. No.: 13/694,876

(22) Filed: Jan. 14, 2013

(51) Int. Cl. B23K 26/38

(52) U.S. Cl. CPC B23K 26/38
USPC 219/121.72; 219/121.67

(57) ABSTRACT

In a method and system for slitting thin strip magnetic steel such as transformer core material, a laser is mounted above the material and the material is wound from a pay-out reel to one or more take-up reels.

### The present application claims priority from U.S. Provisional Patent Application 61/634,123 filed Feb, 22, 2012 in the name of Keith D. Earhart.

### FIELD OF THE INVENTION

The present invention relates to the processing of magnetic steel such as transformer core material. In particular, it relates to the cutting and slitting of amorphous metal and nano-grain steel.

### BACKGROUND OF THE INVENTION

Cutting and slitting of transformer core material such as silicon steel is traditionally performed using steel blades that may be hardened or strengthened in a number of ways as known in the art, in order to increase the longevity of the blade.

The slitting, in particular, of amorphous metal has also traditionally involved the use of mechanical blades, which result in unsatisfactory, often wavy, edge profiles. The added challenge with slitting amorphous metal or other thin materials such as nano-grain steel (collectively referred to herein as thin strip material) is that they are of the order of 1-2 mils thick (1- 2/1000^{th} inch) and have little structural integrity. It is therefore difficult to center the strip of material. The extremely thin material does not lend itself to being edge aligned using an edge plate, since the flimsy material will simply curve and run up the edge plate as it is spooled through the slitter.

A more effective way of slitting amorphous metal and nano-grain steel and controlling the material during slitting is therefore needed.

### SUMMARY OF THE INVENTION

The present invention relates to the processing of transformer core material. In particular it describes a method of controlling amorphous metal strip material and nano- grain steel material, and the slitting and cutting of such material.

According to the invention there is provided a method of cutting or slitting a strip of thin magnetic steel of the order of substantially 1-2 mil thickness, e.g. nano-grain steel or amorphous metal, collectively referred to herein as thin strip material, by cutting the strip using a laser. In particular the strip may be cut or slit using a continuous 20 nm wavelength laser. In order to reduce damage to the edges of the strip due to heating by the laser, the strip may be cooled or quenched by applying a coolant, e.g., by spraying low temperature nitrogen, e.g., low temperature nitrogen gas onto the strip as it is cut. The coolant improves the quality of the edge of the cut and reduces beading of the strip material as it is heated by the laser. Oxygen gas may also be sprayed onto the material as it is cut in order to promote oxidation along the cut edges, thereby providing an oxide coating to the cut edge.

One of the challenges in cutting extremely thin material such as amorphous metal with a laser lies in maintaining a substantially uniform distance between the strip being slit and the laser, and thus keep the strip at the focal point of the laser. The strip may be spooled across a plate from a payout reel to one or more take up reels. The laser may be mounted above the plate and the plate may be provided with one or more apertures located below the laser. The one or more apertures may take the form of a slot configured to reduce fluttering of the strip as gas, such as nitrogen gas or oxygen gas, is sprayed onto the strip. The aperture(s) may also be connected to a low pressure source to suck gas and any debris emanating from the slit strip, away from the plate. The low pressure and aperture may be configured to maintain the strip in contact with the plate to keep the strip at the focal point of the laser, while limiting any distortion of the strip material. One or more magnets may also be mounted to the plate to keep the strip substantially flat against the plate as the strip moves through the focal point of the laser. Since the strip material may not always be planar across its width, the plate may comprise a bevel plate that defines a beveled upper surface to form a central ridge defining a primary abutting region for the lower surface of the strip material as it travels across the plate. The one or more apertures connected to the low pressure source, one or more magnets, and bevel plate may be used in the alternative or in conjunction with one another to assist in maintaining the strip material at the focal point of the laser.

As mentioned above, an amorphous metal strip typically does not have a planar configuration but will include wavy portions that may be more pronounced toward the edges of the strip. One aspect of the present disclosure lies in addressing inherent stresses in the thin strip material, which are released when the material is slit. In order to accommodate these stresses and the resultant varying tensions or lengths of the strips on the downstream side of the slitter, separately driven and controlled take-up reels may be provided.

During slitting operations the strip material may be slit into parallel sided strips of desired width or the strip may be cut or slit at a taper (single or double taper, i.e., at one or both ends of the strip) by slitting the strip using a laser. The taper may be applied to one or both sides (left side or right side or both sides) of the strip.

### BRIEF DESCRIPTION OF THE DRAWINGS

FIG. 1 shows a three dimensional stylized view of one embodiment of a laser slitter arrangement of the present disclosure, and

FIG. 2 shows a three dimensional view of a plate forming part of the slitter arrangement of FIG. 1.

### DETAILED DESCRIPTION OF THE INVENTION

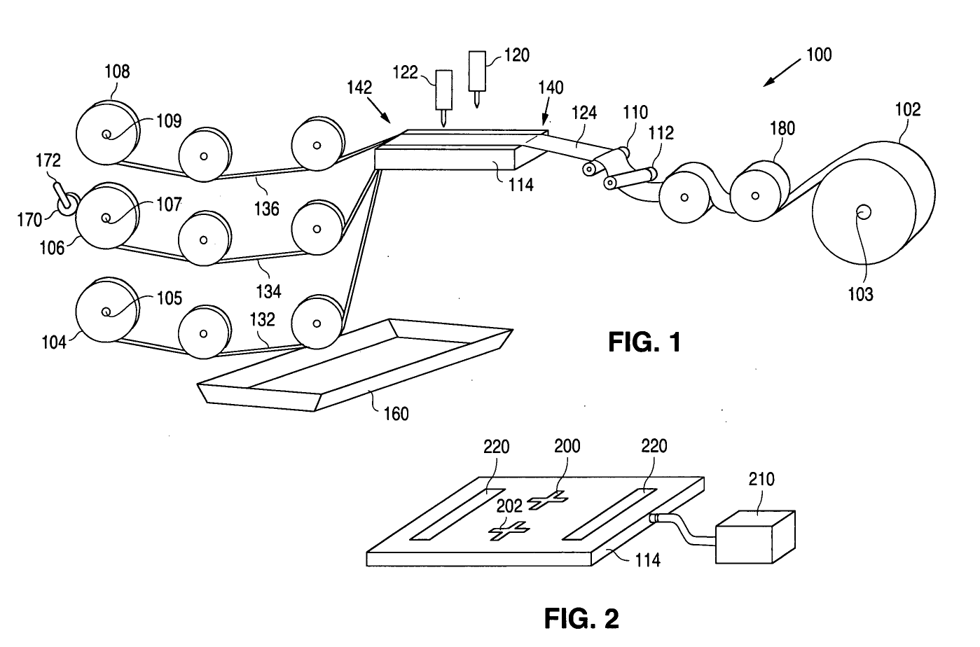

The present disclosure provides a laser slitter arrangement for slitting or cutting thin strip material. In the embodiment of FIG. 1, the laser slitter arrangement includes a winder 100 for winding material from a pay-out reel 102 mounted on a pay-out shaft (depicted by the central circle 103 in the middle of the pay-out reel 102) to at least one take-up reel or mandrel. In this embodiment, three take-up reels 104, 106, 108 are provided, which are mounted on take-up shafts (which are again depicted by central circles 105, 107, 109).

In order to laterally guide the strip material a web guide is provided, which may take any one of a number of forms, e.g., pairs of rollers 110,112 that are axially angled relative to each other, or any other suitable web guide arrangement. The pay-out reel 102 may be provided with a friction brake or an eddy current clutch (not shown) to control the tension of the strip material as it is wound onto the take-up reels 104, 106, 108, or the pay-out reel 102 may be separately driven and the relative speed of the take-up reels adjusted to take account of changes in material build-up on the take-up reels and releases of stress in the material, as is discussed in greater detail below. In this embodiment, each of the take up reels 104, 106, 108 is individually driven and controlled to maintain a uniform tension for each of the strips 132, 134, 136 on the downstream side of the lasers

As shown in FIG. 1, in this embodiment a first laser 120 and a second laser 122, laterally separated from each other, are mounted above the incoming strip material 124, thereby allowing the incoming strip on the upstream side 140 of the laser to be slit into three strips, thereby providing strips 132, 134, 136 on the downstream side 142 of the lasers. In this embodiment the lasers 120, 122 are 20 nm continuous wavelength lasers. The lateral position of the lasers may be chosen to provide at least one strip 134 of a desired width, and two side strips 132, 136 that may themselves be of a desired width or that may subsequently be slit further, or constitute scrap or drop. It will be appreciated that in a simplified embodiment only one laser and one or two take up reels may be provided. If all three strips are to be retained, three take up reels 104, 106, 108 are used to receive the strips of material on the downstream side 142. On the other hand if only one or two of the strips are to be retained, the strip or strips that are to be discarded can either be wound onto take up reels or allowed to accumulate in a drop box 160.

It is desirable to maintain a substantially uniform distance between the strip being slit and the laser in order to keep the strip at the focal point of the laser. This improves the quality of the edge of the cut and reduces beading of the strip material as it is heated by the laser. In this embodiment, apertures 200, 202 in the form of longitudinally and laterally extending slots are provided in the plate 114 as shown in FIG. 2. The lasers 120, 122 are mounted above the apertures 200, 202 and the slot size and shape is configured to reduce fluttering of the strip as nitrogen gas and oxygen gas (discussed further below) are sprayed onto the strip. The apertures avoid blow-back or gas deflection from the plate and thus reduce fluttering of the material. The laterally extending slots accommodate lateral movement of the lasers. The plate can also be moved in conformity with the movement of the lasers, thereby avoiding the need for laterally extending slits. It will be appreciated that if the two lasers need to be moved laterally independently of each other, e.g., in order to slit non-parallel-sided strips, the plate 114 may be implemented as a split plate to allow each portion of the plate to move independently under each of the lasers. The apertures 200, 202 extend to a channel formed in the plate (not shown), which is connected to a low pressure source 210, such as a vacuum pump, to suck the gas and any debris emanating from the slit strip, away from the plate. The low pressure source and apertures may be configured to maintain the strip in contact with the plate to keep the strip at the focal point of the lasers. Alternatively, or in addition, one or more magnets may also be mounted beneath or into the plate 114 as depicted by the magnets 220 to keep the strip substantially flat against the plate as the strip moves across the plate 114 through the focal points of the lasers.

In this embodiment the upper face of the bevel plate 114 tapers downward laterally from a central longitudinal line that extends in a direction from the upstream to the downstream side and corresponds to the center line of the incoming strip 124. The resulting central, longitudinally extending ridge of the bevel plate 114 helps provide an abutting surface along the center line of the lower face of the strip 124 since the strip material typically has non-planar faces with increased unevenness or waviness toward the edges of the strip. This beveled plate configuration therefore also helps keep the material at the focal points of the lasers. Tension of the strip material is controlled in one embodiment by providing a load cell in the shaft supporting the upstream rollers 180 and controlling the tension on the pay-out reel 102 using a friction brake or an eddy current clutch. However, it will be appreciated that the strip or web positioning and tension control can instead be achieved in other ways. In the embodiment illustrated in FIG. 1, the take-up reels 104, 106, 108 are individually driven and their speeds separately controlled by a controller in relation to the pay-out reel 102, which may also be driven by a controllable motor drive or controlled using a friction break or eddy current clutch, as discussed above. By controlling the take-up reels separately, the stresses and variations in tension across the width of the incoming strip material can be taken up as they are released down-stream of the lasers.

In one embodiment, where multiple slitting operations are to be performed simultaneously, instead of mounting multiple lasers, a single laser can be used and a beam splitter mounted in the laser beam to provide multiple laser beams.

In one embodiment, in which strips with non-parallel sides are to be slit, the positions of the lasers 120, 122 and the position of the plate 114 or plate sections (depending on the number of laser beams) may be laterally adjustable and can be controlled relative to the linear distance travelled by the strip material, i.e., relative to the amount of strip material that has passed through to the downstream side, or relative to the build of the material on any one of the take-up reels 104, 106, 108. In the embodiment of FIG. 1 a sensor in the form of a roller 170 mounted on a pivot arm 172 provides feedback on the build of the material on the middle take up reel 106. This allows the width of the wound ring to be adjusted in relation to the build or thickness of the ring, thereby allowing rings of desired profile to be wound. The roller 170 and pivot arm 172 also serve to provide feedback on the build of the material on the take up reel 106, thereby allowing the motor driving the take up reel to be adjusted to maintain a constant linear speed to the strip material and thereby avoid variations in the cut quality by the constant power laser(s). In another embodiment the build of the ring(s) can be calculated by the number of layers wound onto the take-up reel or mandrel, as defined by the number of rotations of the take-up reel.

It will thus be appreciated that the lateral position of the lasers 120, 122 can be controlled to provide wound rings with a desired cross-sectional profile. For example, in one embodiment, only the central 134 strip is retained while the left and right strips 132, 136 are either discarded or wound onto take up reels for subsequent further processing. The central strip 134 can thus be shaped to form a ring having a circular cross-sectional profile. Instead, the sides of the incoming strip may be trimmed toward the leading and trailing ends of the strip to provide a single strip with tapered ends. The length and shape of the taper can be chosen to achieve a ring with a cross-sectional profile that is either, substantially circular, octagonal, or square with rounded corners.

In the embodiment of FIG. 1 the lasers 120, 122 are mounted to be moveable laterally. However, in order to achieve relative lateral movement between the laser beams produced by the lasers 120, 122 and the thin strip material as it travels longitudinally across the plate 114, the lateral positioning of the laser beams can instead be controlled by providing adjustable mirrors, e.g., mirrors mounted on gimbals to reflect the laser beams to the desired location on the thin strip material or, in the case of a single laser, making use of a beam splitter, as discussed above, and controlling the resultant split beams. If only one beam and one slit is to be made, instead of moving the laser or laser beam, the lateral position of the thin strip material can be adjusted so that the strip itself is moved laterally relative to the laser. All of these methods will be referred to herein as implementations in which laser beams are controlled to be laterally moveable relative to the thin strip material.

In order to reduce damage to the edges of the resultant strips due to heating by the laser and to blow away debris and volatilized material from the laser heating process, a cooling gas is blown onto the strip at the cutting point. In this embodiment low temperature nitrogen gas is sprayed onto the strip from a nozzle surrounding the laser as the strip is slit. Oxygen gas is added to the nitrogen gas in this embodiment to promote oxidation along the cut edges, thereby promoting an oxide coating to the cut edges.

While the invention has been described with respect to specific embodiments it will be appreciated that the invention is not so limited but includes other implementations as defined by the scope of the claims and as may be readily determined by someone familiar with the art.

What is claimed is:

1. A method of slitting a strip of amorphous metal or nano-grain steel (collectively, referred to herein as thin strip material), comprising,
winding the thin strip material from a pay-out reel to one or more take-up reels and slitting the thin strip material using a laser as it is wound from the pay-out reel to the one or more take-up reels.

2. A method of claim 1, further comprising mounting at least one laser above the thin strip material as it is wound from the pay-out reel onto the at least one take-up reel.

3. A method of claim 2, wherein the at least one laser is a continuous 20 nm wavelength laser.

4. A method of claim 2, further comprising cooling the thin strip material as it is being slit.

5. A method of claim 4, wherein the cooling comprises spraying nitrogen gas onto the strip material.

6. A method of claim 2, comprising spraying oxygen gas onto the thin strip material as it is being slit.

7. A method of claim 5, comprising providing an oxygen-nitrogen gas mixture.

8. A method of claim 4, further comprising providing a plate below the at least one laser for supporting the thin strip material as it is spooled from the payout reel to the at least one take up reel.

9. A method of claim 8, further comprising providing the plate with at least one aperture, operably located below the one or more lasers.

10. A method of claim 8, wherein the aperture is connected to a low pressure source.

11. A method of claim 8, further comprising mounting one or more magnets on the plate.

12. A method of 8, wherein the plate is a bevel plate.

13. A method of claim 8, wherein the at least one laser is mounted to provide one or more laser beams that are laterally moveable relative to the thin strip material as it moves longitudinally across the plate.

14. A method of claim 8, further comprising providing multiple separately driven take-up reels and controlling their speeds independently to take account of releases in stress in the material as it is slit.

15. A laser slitter for slitting strip material, comprising
a payout shaft for receiving a pay-out reel, and at least one take-up shaft for receiving at least one take-up reel or mandrel, the pay-out and take-up shafts defining an upstream and a downstream side, respectively, for strip material wound between the upstream side and the downstream side, and
at least one laser operably mounted between the upstream side and the downstream side.

16. A laser slitter of claim 15, further comprising a plate mounted between the upstream side and the downstream side for supporting the strip material as it passes between the upstream side and the downstream side.

17. A laser slitter of claim 15, further comprising means for laterally guiding the strip material as it is wound from the pay-out reel to the at least one take-up reel or mandrel.

18. A laser slitter of claim 15, wherein the plate includes at least one aperture, and the at least one laser is mounted above the at least one aperture in the plate.

19. A laser slitter of claim 18, further comprising a low pressure source connectable to the at least one aperture.

20. A laser slitter of claim 15, where the plate is provided with at least one magnet for urging the strip material toward the plate as the strip material passes over the plate.

21. A laser slitter of claim 15, further comprising a source of cooling gas for spraying cooling gas onto the strip material as it is slit.

22. A laser slitter of claim 21, wherein the cooling gas includes at least one of nitrogen and oxygen.

23. A laser slitter of claim 15, wherein the payout shaft is connected to a controllable braking mechanism or a controllable motor drive.

24. A laser slitter of claim 23, further comprising a sensor or one or more counters for determining the build on at least one of the take-up reels.
